(19) United States
(12) Patent Application Publication
(10) Pub. No.: US 2011/0310627 A1
(43) Pub. Date: Dec. 22, 2011

(54) POSITIONING STRUCTURE FOR A TABLE LAMPL

(76) Inventor: Ching-Long Liang, Rende Shiang (TW)

(21) Appl. No.: 12/818,150

(22) Filed: Jun. 18, 2010

(51) Int. Cl. F21V 21/30

(52) U.S. Cl. 362/427

(57) ABSTRACT

A positioning structure for a table lamp includes a base provided with a connecting stand and a support post with a pivotal seat. The pivotal seat has one side formed with an accommodating chamber and another side bored with an insert hole communicating with the accommodating chamber. An extension rod pivotally assembled with the pivotal seat is secured with fixing member having a support shaft at one side, the support shaft having an outer wall formed with a male thread section and an interior bored with a through hole having an outer end provided with a female thread section. A positioning member made of silica gel is fitted on the support shaft. A nut having a threaded hole and an insert hole is screwed on the support shaft, and a screw. is inserted through the nut and screwed in the female thread section of the extension rod.

### BACKGROUND OF THE INVENTION

1. Field of the Invention

This invention relates to a positioning structure for a table lamp, particularly to one able to stably position the extension rod of a table lamp to prevent the extension rod from getting loose.

2. Description of the Prior Art

As commonly known, a table lamp is employed to strengthen indoor light for facilitating reading or working. A conventional table lamp is mostly provided with a pivotal seat on the support frame of a lamp-shade to be pivotally combined with a base so as to enable the lamp-shade to move up and down or backward and forward for adjusting lighting angles. The conventional table lamp has the pivotal seat and the support frame of the lamp-shade locked together by means of a screw member so that the lamp-shade at the upper end of the support frame can be positioned at a desired lighting angle. However, the pivot joint of the conventional support frame of the lamp-shade is positioned by screw locking; therefore, after used for a period of time, the pivot joint is likely to get loosened and as a result, the support frame will be impossible to be stably fixed in place and fail to support the lamp-shade.

### SUMMARY OF THE INVENTION

The objective of this invention is to offer a positioning structure for a table lamp, able to stably position the extension rod of a table lamp and prevent it from getting loose.

The positioning structure for a table lamp in the prevent invention includes a base provided thereon with a switch and a connecting stand with a support post. A pivotal seat is assembled at the upper end of the support post, having one side formed with an accommodating chamber and another side bored with an insert hole communicating with the accommodating chamber. An extension rod is pivotally assembled on the support post of the base, having its upper end disposed with a universal joint connected with a lamp shade and its lower end fixed with a balance weight. The extension rod is further provided thereon with a fixing member having one side secured with a transverse support shaft to be inserted in both the accommodating chamber and the insert hole of the pivotal seat. The support shaft has an outer wall provided with a male thread section and its interior bored with a through hole having its outer end disposed with a female thread section. A positioning member made of silica gel is fitted on the support shaft of the extension rod and bored with a through hole. A gasket is positioned at an outer side of the fixing member of the extension rod, and a nut assembled at another side of the gasket has one end disposed with a threaded hole to be screwed with the male thread section of the support shaft and another end bored with an insert hole communicating with the threaded hole. A screw is inserted in the insert hole of the nut and threadably locked in the female thread section of the extension rod.

### BRIEF DESCRIPTION OF DRAWINGS

This invention will be better understood by referring to the accompanying drawings, wherein:

FIG. 1 is a perspective view of a positioning structure for a table lamp in the present invention;

FIG. 2 is an exploded perspective view of the positioning structure for a table lamp in the present invention;

FIG. 3 is a cross-sectional view illustrating that the fixing member of an extension rod is not yet pivotally locked with the pivotal seat of a support post in the present invention;

FIG. 4 is a cross-sectional view illustrating that the fixing member of the extension rod is pivotally locked with the pivotal seat of the support post in the present invention; and

FIG. 5 is a schematic view of the positioning structure for a table lamp in a using condition in the present invention.

### DETAILED DESCRIPTION OF THE PREFERRED EMBODIMENT

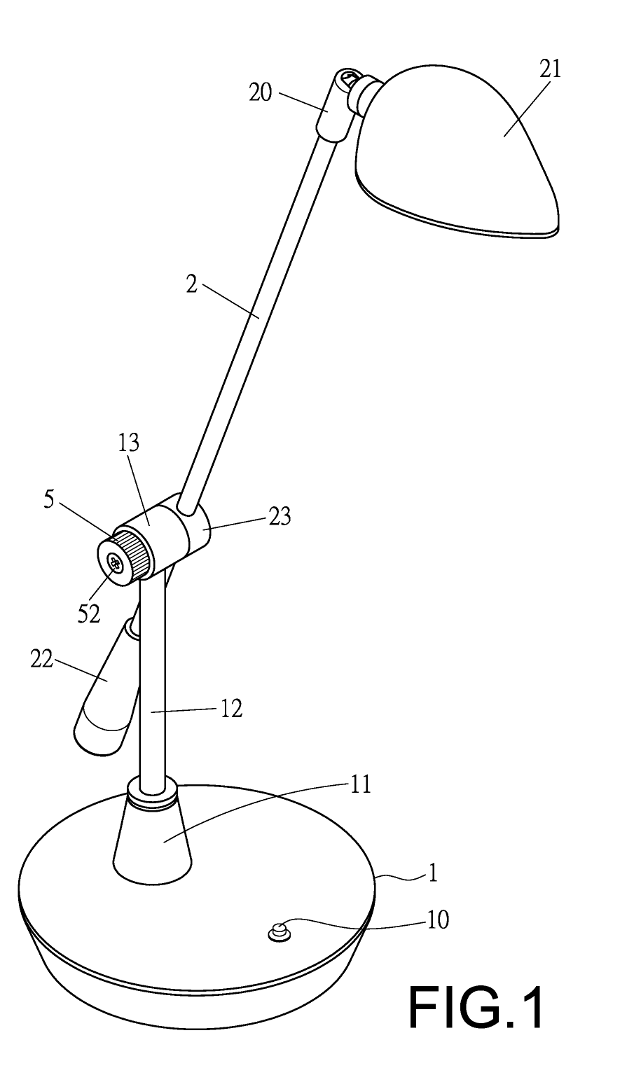

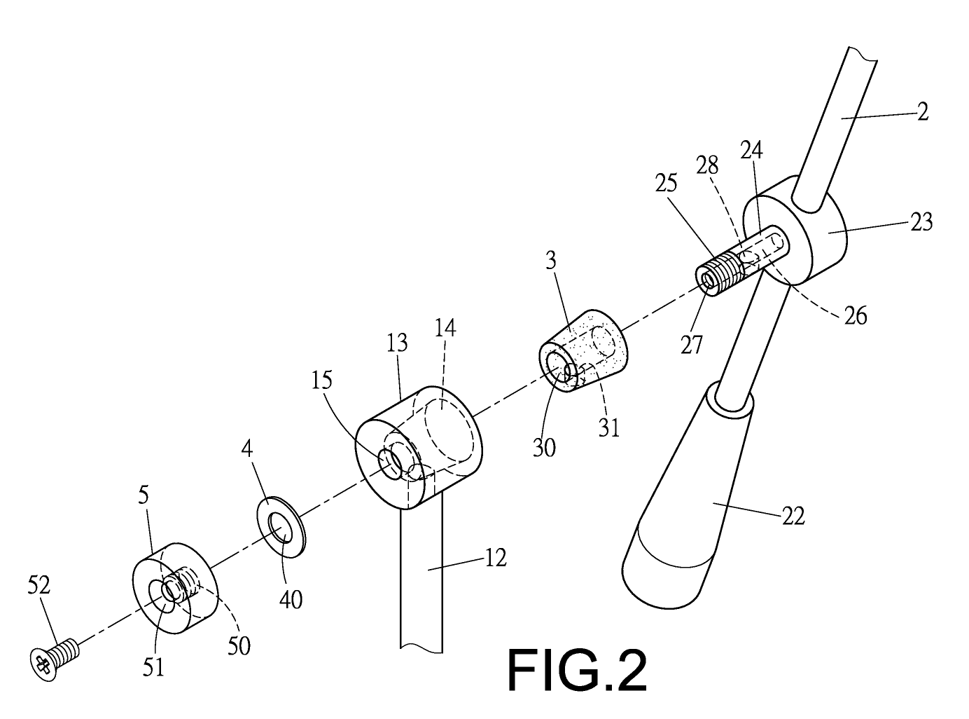

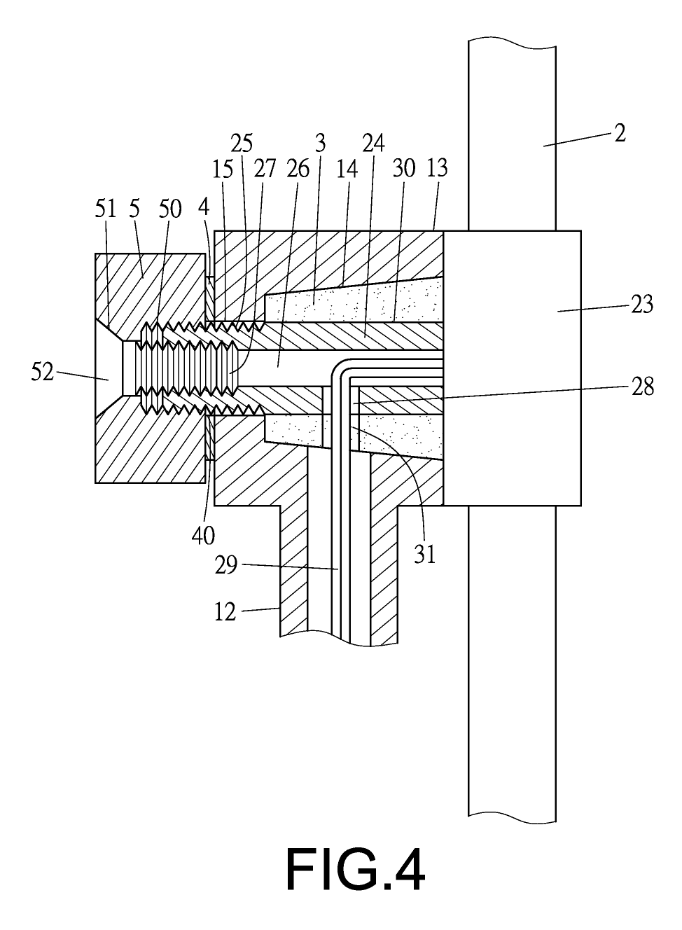

A preferred embodiment of a positioning structure for a table lamp in the present invention, as shown in FIGS. 1 to 4, includes a base 1, an extension rod 2, a positioning member 3, a gasket 4 and a nut 5 as main components combined together.

The base 1 is provided with a switch 10 and a connecting stand 11 thereon. The connecting stand 11 is disposed with a hollow support post 12 having its topside assembled with a pivotal seat 13 that has one side formed with an accommodating chamber 14 with a conical inner wall shrunken gradually from the outside to the inside, and another side bored with an insert hole 15 communicating with the accommodating chamber 14.

The extension rod 2 is a hollow one pivotally assembled on the support post 12 of the base 1, having its upper end provided with a universal joint 20 connected with a lamp-shade 21 and its lower end set with a balance weight 22. Further, the extension rod 2 is disposed with a fixing member 23 having one side secured with a transverse support shaft 24 formed with a male thread section 25 on the outer wall and bored in the interior with an through hole 26 with a female thread section 27. The support shaft 24 further has its outer wall bored with an insert hole 28 for an electric wire 29 to be inserted therethrough.

The positioning member 3 made of silica gel is to be fitted on the support shaft 24 of the extension rod 2, having a conical outer wall whose outer diameter is larger than the inner diameter of the accommodating chamber 14 of the pivotal seat 13, and having its interior formed with a through hole 30 and its wall bored with an insert hole 31 communicating with the through hole 30.

The gasket 4 with an insert hole 40 is to be positioned at an outer side of the fixing member 23 on the extension rod 2.

The nut 5 is to be assembled at another side of the gasket 4, having one end disposed with a threaded hole 50 and another end bored with an insert hole 51 communicating with the threaded hole 50. A screw 52 is engaged with the insert hole 51 of the nut 5 and screwed in the female thread section 27 of the extension rod 2.

In assembling, referring to FIGS. 1 to 4, firstly, the positioning member 3 is fitted on the support shaft 24 on the fixing member 23 of the extension rod 2, letting the support shaft 24 inserted through the through hole 30 of the positioning member 3. Next, the support shaft 24 fitted thereon with the positioning member 3 is inserted in the interior of the pivotal seat 13 at the upper end of the support post 12, letting the outer end of the support shaft 24 inserted in the insert hole 15 of the pivotal seat 3, and meanwhile the positioning member 3 with a conical outer wall is pressed fit in the cone-shaped accommodating chamber 14 of the pivotal seat 13. Subsequently, the gasket 4 and the nut 5 are orderly pushed closely against one side of the pivotal seat 13 and then have the nut 5 firmly screwed with the male thread section 25 of the support shaft 24 and lastly, a screw 52 is inserted in the insert hole 51 of the nut 5 and screwed in the female thread section 27 of the support shaft 24. When the support shaft 14 is threadably locked by both the nut 5 and the screw 52, the positioning member 3 that is fitted on the support shaft 24 will be sandwiched and pressed into the accommodating chamber 14 of the pivotal seat 13. Thus, the positioning member 13 made of silica gel and having great elasticity can be forced to closely resist against the inner wall of the accommodating chamber 14 and stably position the support shaft 24 in the pivotal seat 13, convenient and quick in assembly and able to prevent the support shaft 24 from rotating and shifting.

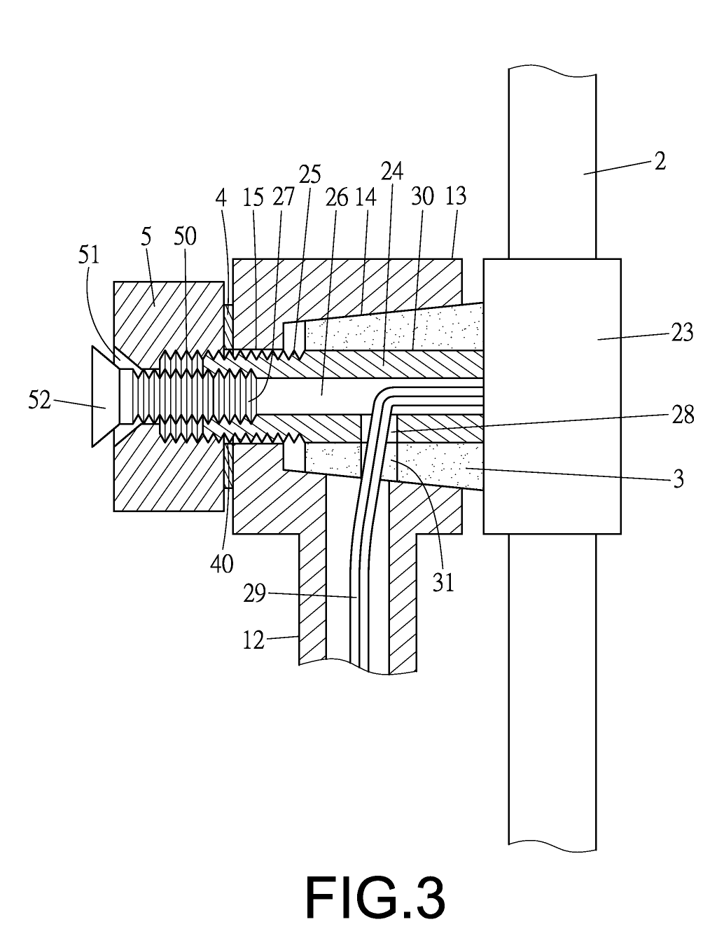

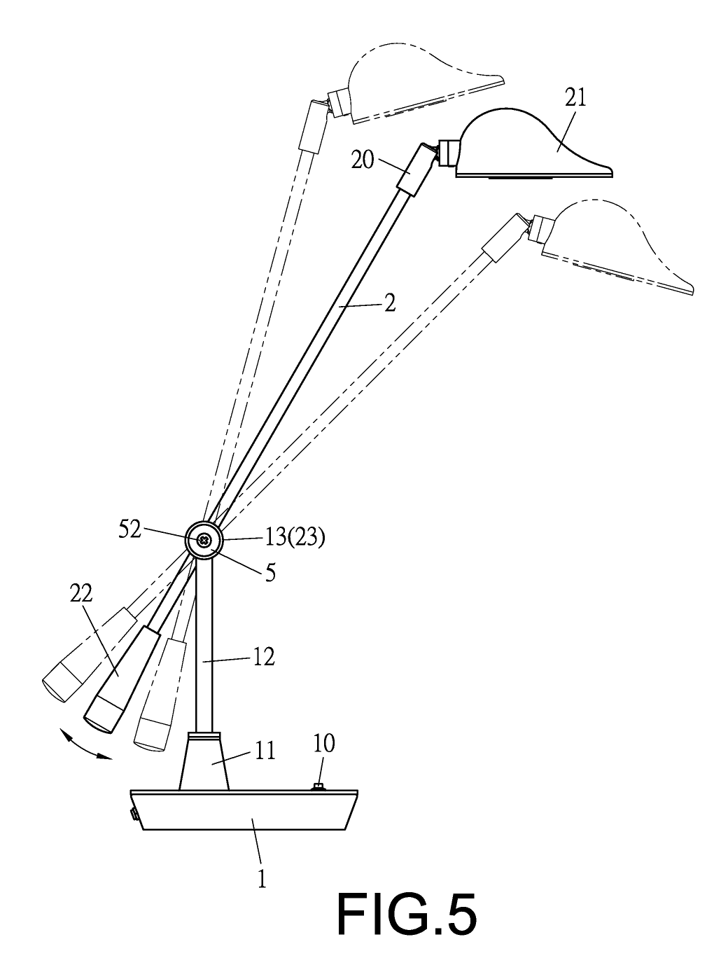

Referring to FIGS. 3, 4 and 5, to adjust lighting angles of the lamp shade 21, simply pull the extension rod 2 with a little force to a slant angle desired. The support shaft 24 of the extension rod 2 is firmly held by the positioning member 3 that is tightly pressed fit in the accommodating chamber 14 of the pivotal seat 13, and has an excellent frictional force due to its silica gel material. Therefore, when both the nut 5 and the screw 52 are threadably locked with the support shaft 24 to closely press the positioning member 3 in the accommodating chamber 14 of the pivotal seat 13, the support shaft 24 on the extension rod 2, which is fastened in the pivotal seat 13, will impossible to be rotated and shifted, and thus the extension rod 2 can surely be stably kept in position not to get loose. In addition, the balance weight 22 fixed at the lower end of the extension rod 2 can function to balance the extension rod 2 at a slant angle desired, and the universal joint 20 assembled at the upper end of the extension rod 2 can be moved to adjust the lighting angles of the lamp shade 21 as a user pleases.

While the preferred embodiment of the invention has been described above, it will be recognized and understood that various modifications may be made therein and the appended claims are intended to cover all such modifications that may fall within the spirit and scope of the invention.

What is claimed is:

1. A positioning structure for a table lamp comprising a base, said base provided thereon with a switch and a connecting stand, said connecting stand disposed with a support post having a pivotal seat set thereon, said pivotal seat having one side formed with an accommodating chamber and another side bored with an insert hole communicating with said accommodating chamber, an extension rod pivotally assembled on said support post of said base, said extension rod having an upper end installed with a universal joint connected with a lamp shade and a lower end fixed with a balance weight, said extension rod mounted with a fixing member having one side secured with a support shaft to be inserted in both said accommodating chamber and said insert hole of said pivotal seat, said pivotal seat having an outer wall provided with a male thread section, said support shaft having an interior bored with a through hole having an outer end formed with a female thread section, a positioning member fitted on said support shaft of said extension rod, said positioning member made of silica gel and formed with a through hole, a gasket assembled at an outer side of said fixing member, a nut fixed at another side of said gasket, said nut having one end formed with a threaded hole to be screwed with said male thread section of said support shaft and another end bored with an insert hole communicating with said threaded hole, a screw member inserted in said insert hole of said nut and screwed with said female thread section of said extension rod.

2. A positioning structure for a table lamp as claimed in claim 1, wherein said accommodating chamber of said pivotal seat is formed with a conical inner wall shrunken gradually from an outside to an inside, and said positioning member is formed with a conical outer wall.

3. A positioning structure for a table lamp as claimed in claim 1, wherein an outer diameter of said positioning member is larger than an inner diameter of said accommodating chamber of said pivotal seat.

4. A positioning structure for a table lamp as claimed in claim 1, wherein said support post is hollow and so is said extension rod so that an electric wire can be inserted in the interior of both said support post and said extension rod, said support shaft on said fixing member of said extension rod having an outer wall bored with an insert hole communicating with said through hole and said positioning member also having a wall bored with an insert hole communicating with said through hole for enabling an electric wire to be inserted therethrough.
